(19) United States
(12) Patent Application Publication
(10) Pub. No.: US 2007/0284123 A1
(43) Pub. Date: Dec. 13, 2007

(54) Back saver weeder

(76) Inventor: Elliot W. Lee, (US)

Correspondence Address: Law Offices of Michael McEntee, Suite 100, 15802 Chemical Lane, Huntington Beach, CA, 92649, US

(21) Appl. No.: 11/439,938

(22) Filed: May 23, 2006

(51) Int. Cl. A01B 1/00

(52) U.S. Cl. 172/378

(57) ABSTRACT

The present invention is a hand held tool for brush and weed removal. It is a long or short handled weed extraction implement having combined features that facilitate easy and efficient weeding of all varieties of short and tall brush, bushes, bamboo, and the like. Further, the present invention is ideal for gathering the brush, weeds, and other debris, without changing tools. The invention is also adapted to loosening and leveling of the soil, again without changing tools. Unlike all other hand held weeding tools, the invention has a file for sharpening the tines and blade elements from time to time during the day while the tool is in the field. The file is mounted axially in the handle for convenience and to protect the file from rusting. The skill normally required for free-hand sharpening of blades is greatly reduced by the unique interfit of the file and elliptical shaped cutting edges. The invention also tends to induce better, safer, more ergonomic work habits among those who use the invention.

### CROSS REFERENCE TO RELATED APPLICATIONS

None

### FEDERALLY SPONSORED RESEARCH

None

### SEQUENCE LISTING OR PROGRAM

None

### BACKGROUND OF THE INVENTION

1. Field of the Invention

The present invention is a hand held tool for brush and weed removal. It is a long or short handled weed extraction implement having combined features that facilitate easy and efficient weeding of all varieties of short and tall brush, bushes, bamboo, and the like. Further, the present invention is ideal for gathering the brush, weeds, and other debris, without changing tools. The invention is also adapted to loosening and leveling of the soil, again without changing tools. Unlike all other hand held weeding tools, the invention has a file for sharpening the tines and blade elements from time to time during the day while the tool is in the field. The file is mounted axially in the handle for convenience and to protect the file from rusting. The skill normally required for free-hand sharpening of blades is greatly reduced by the unique interfit of the file and elliptical shaped cutting edges. The invention also tends to induce better, safer, more ergonomic work habits among those who use the invention. This is particularly important to those who are exposed to prolonged weeding activity.

2. Description of the Prior Art

Weeding by means of hand tools includes several categories of tools. Broadly, it includes: (1.) Scythes for removal of surface growth, (2.) Various hoes, awls, and rakes for tearing at the roots of the weeds as well as removing surface growth, and (3.) Shovel weeding and cultivating.

The first category, utilizing hoes and awls probably goes back to the iron-age adz which was used like the modem awl. One example of a modem awl includes the “Pulaski.” Fire crew “hot shot” teams utilize a “Pulaski” type awl for clearing low lying brush, up to 1 or 2 feet high, and chopping down trees, in order to slow the progress of a wildfire. The present invention could augment “hot shot” teams in that half the team would carry the invention and the other half carry Pulaski type awls. The result would be an important increase in the team's ability to clear fire breaks because the invention combines a scythe feature in combination with robust tines on the opposite edge the tool head is well adapted to rapidly clear brush and tall grass six or more feet high, and would achieve a faster result without as much difficult labor.

A “Pulaski” has no means of carrying a sharpening tool to reshape and sharpen its cutting edge. As the edge gets worn over the hours it is used, the penetrating power decreases, and the effort to cut through roots increases substantially. When used to clear brush, a “Pulaski” operates like an inefficient scythe, cutting a width of grass about 4 inches wide, for a distance of about 18 inches. The sweep of the blade acts to propel the weeds a distance of a few feet. The user must bend over throughout the cutting stroke, and the work is backbreaking and exhausting. The present invention gives a much broader sweep of the scythe-like cutting, and permits a wider scraping of the ground with the rake feature inherent in the side tines, and the front of the tool head has a combination of tines and a squared cutting edge to break through and cut tough roots and vegetation, all with the same tool.

Another use for the invention is right-of-way maintenance, wherein the maintenance crew need only utilize the present invention, without having to carry several separate tools such as a scythe, shovel, saw and rake. Such work typically involves working in soil loaded with gravel and cobbles. The hand tools soon lose their sharpness. Loss of sharpness translates into less ability to cut the weeds, brush and bushes. Conversely, it results in more effort needed be stroke to get the job done. The present invention utilizes robust tines, sharpened multiple of cutting surfaces, and a file sharpening means for shaping and lapping the cutting surfaces.

Another use of the invention is to ease home gardening. Modem gardeners have less free time to devote to gardening. They want to get the weeding done quickly. Because home gardening is generally done on a small scale such as a flower bed, backyard or kitchen garden, it is generally not economical or practical to utilize practices used in the commercial agricultural industry. As a result, a home gardener accumulates a rake, a scythe, a hoe, a shovel, and small versions of these tools, like scoops and trowels, for planting, cultivating and maintaining the garden. Among the most distasteful of the tasks facing a home gardener is that of eradicating weeds from the garden.

Perhaps the most important object of the invention is in reducing mulculosketal injury among farm workers. In a study of work related musculoskeletal disorders (MSDs) among agricultural workers, conducted by researchers from the University of California, the researchers found: “Work-related musculoskeletal disorders are rising in incidence and account for a majority of workers' compensation dollars. They are increasing in incidence and concern in California, which has just implemented the first occupational health standard for ergonomics in the U.S. . . .”

“Occupational musculoskeletal disorders (MSDs) may affect muscles, tendons, joints, nerves and related soft tissues anywhere in the body. The lower back and upper extremities, including the neck and shoulders, are the most common sites. Because repeated risk factor exposure of the same muscle, tendon, or region may result in injury and inflammation to the affected area, names such as cumulative trauma disorder, repetitive motion injury, repetition strain injury, and occupational overuse syndrome have been applied to these disorders.

“Work-related musculoskeletal disorders (MSDs) are rising in incidence and account for a majority of workers' compensation costs (Guo et al., 1995). They are increasing in incidence in California, which has consistently experienced injury rates higher than the national average in all industries (Robinson, 1988). Of greatest concern are back injuries which are the most frequently cited cause of disability in persons aged 45 or less (Andersson, 1981), account for most lost time from work (Clemmer et al., 1991), and account for a significant proportion of workers' compensation costs (Nagi et al., 1973; Spengler et al., 1986; Robinson, 1988, Webster and Snook, 1990; Glisan, 1993).

Concern is also growing about cumulative injuries to upper extremity nerves and soft tissues resulting from repetitive motions. The number of work-related cases of cumulative trauma disorders (CTDs) have significantly increased in the past several years and in 1989 accounted for more than half of all work-related illness cases. According to the 1993 National Ambulatory Medical Care Survey (CDC, 1998) more than 60% of all injury visits were to orthopedists, with “sprains and strains of joints and adjacent muscles” comprising the most frequent diagnosis category for all ages except for persons under 15 years old. Despite surveillance gaps MSD cases appear to be increasing faster than any other occupational illness category (BNA, 1991). In California, “cumulative injuries” claims comprise a share that is twice the size of any other specific injury category (California Department of Insurance et al., 1993).

The study examined the “ERGONOMIC RISK FACTORS” and concluded:

“There is evidence that these disorders (MSDs) result from repeated biomechanical stress due caused by ergonomic hazards (USDOL, 1990). Silverstein et al. (1986, 1987) demonstrated a relationship between occupational exposures (specifically those with high force-high repetitious tasks) and pathology

“Review of California worker's compensation system reports suggests that 43% of all reported injuries in California agriculture were sprains and strains. Overexertion as a cause of injury for this area was cited for 25% of reported injuries. These data suggest a high proportion of musculoskeletal disorder incidence and ergonomic risk factors . . . . ”

The study focused particularly on shovel weeding done by agricultural workers, and described the process of such weeding and the risks as follows:

“3. Shovel Weeding

“The worker works along a vine row, reaching towards and under the vines with a shovel to cut weeds away with the front edge of the shovel blade. During the cutting movements, moderate to severe trunk flexion (forward bending of 30-90 degrees); and mild to moderate body twisting (20-30 degrees) were observed.

“Moderate shoulder and arm forces are applied by swinging the shovel with the arms so that the blade impacts and cuts the root of the weed. High static grip forces are sustained by both hands on the shovel handle for periods of 12-33 seconds during the weeding. Workers typically make 50-60 cutting motions per minute. Mild to moderate wrist extension is present throughout the activity. Shoulder extension is moderate (up to 60 degrees). Neck position -is technically close to neutral, but since the trunk is in prolonged flexion of 30-90 degrees, the neck is in a posture that is difficult to maintain for long periods due to muscle fatigue.

“Mild grip forces are needed to hold the shovel during the 10-11 seconds of walking to the next area to be weeded.”

The study determined that the TASK TIME was 12-33 seconds of swinging the shovel to cut and 10-11 seconds to walk to the next position for a Total Job Cycle of 22-44 seconds.

One can infer that over 21,000 cutting strokes a day are typical while weeding. Thus, any feature of the weeding tool which causes the worker, ever so slightly, to adapt to a more upright, more balanced, and less forceful mode of weeding will likely result in less MSD, as well as leading to higher productivity.

Numerous hand tools have been developed over time for the purpose of facilitating weed removal. However, many of these tools suffer from drawbacks that affect their usefulness. Claw or jaw weeding devices have a pair of blades that are designed to be placed next to the main stem of the weed and dug in below to remove the weed and roots. However, such devices are tedious to use since they may be used on only one weed at a time, they require exact placement, and they call for the user to stoop or kneel to the weed to properly cut the weed and remove it. For those persons suffering from physical impairments or disabilities, bending or kneeling repetitively to remove weeds may be prohibitively difficult, painful, or exhausting. Moreover, if improperly used, such claws or other similar tools may merely cut off the weed at the surface, leaving the severed weed and leaving intact the root structure below. The severed weed may still spread seeds into the garden, and the weed is likely to grow back from the old root system requiring the process to be repeated.

Both in agricultural work and in home gardening, it is also often necessary to utilize more than one tool to adequately perform the weeding function. First, a hoe, shovel, pick or cultivator is used to loosen up the soil around the weeds. Then a claw, rake, or jaw is used to remove the weeds. Finally, a rake is used to remove the severed weeds. This increases the time and effort necessary for the task of weed removal, making it even less desirable to do.

An object of this invention is to provide a weeding tool that is capable of efficiently removing both a weed and substantially all of its associated root system, and that does not require the user to kneel, stoop, bend over or grab hold of the weed when it is in the ground, making the tool more available for use by persons having physical limitations.

Another object of this invention is to reduce the muscular force and the impact upon the limbs and abdomen of the person using the invention by keeping the cutting edges of the tool sharp throughout the time the tool is used.

Another object is to induce better ergonomic habits in the use of the tool without the person having to read a manual, or adopt an artificial and “unnatural” stance in using the tool. In this manner, the person the person using the invention will avoid musculoskeletal disorders.

Another object is to allow use of the person's foot to force the tool into hard-packed ground without losing their balance and without undue coordination.

### SUMMARY OF THE INVENTION

The present invention provides a useful and conveniently combined weeding tool that may be used to easily and efficiently remove weeds, dig or level the soil, and plant seeds all without repetitive kneeling or stooping. The invention includes a long or short handle attached to a unique arrangement of cutting surfaces distributed about a preferably concave metal surface. The arrangement is also characterized by a non-symmetrical arrangement of sharpened tines, hollow ground serations, and squared sharpened blades.

Unlike pointed trenching tools, the front edge of the tool has a combination of a sharpened blade, typically about 1 inch wide, oriented at substantially 70 to 90 degrees to the major axis of the tool, and located just to one side of the major axis of the tool. Immediately on the other side of the major axis of the tool is located at least two, or more, sharpened tines, oriented substantially parallel to the major axis of the tool, and having a length just enough so that the tool, when it contacts hard-pan dirt, will not jerk to the left or the right as the user applies thrust to the tool to cause it to enter the soil. By contrast, a round head shovel inherently wobbles to the one side or the other as the user places their foot on the shovel to drive the round head into the hard ground.

The weed removal sections of the unique head are found around the periphery of the metal surface and includes a plurality of cutting surfaces and tines. The tines and the rest of the geometry of the surface is formed by a series of metal blanking and forming operations well known to the metal forming industry.

### DESCRIPTION OF DRAWINGS

FIG. 1 is a perspective view of one of the two preferred embodiments.

FIG. 2 is a plan view of the top surface of the tool head of the other preferred embodiment.

FIG. 3 is a close up view of the scallop cutting elements along the side 60 of FIGS. 1 as well as FIG. 2.

FIG. 4 is a close up view of the region 80 and 83 as shown in FIG. 1 and 2.

FIG. 5 is a close view of the file 100 and the top of shaft 20.

FIG. 6 is a plan view of the rear of the toolhead of the second preferred embodiment.

FIG. 7 is a plan view of the rear showing clip 140 on shaft 20.

FIG. 8 is a broken out sectional view along axis 8a-8b as shown in FIG. 9.

FIG. 9 is a top view showing in dotted lines the elliptical profile of the typical sharpenable cutting edge 88c. A similar elliptical profile is found in the scallops 61a, 61b, 61c, . . . and is sharpenable in the same manner.

FIG. 10 is a cross sectional of the file, showing a half-round cutting ridge 102 and a flat top cutting ridge 101. The diameter 86 is matched to the diameter of the sharpenable edges such as shown in FIG. 4, at 88c.

FIG. 11 is an alternative means of firmly attaching the clip 141 to the shaft 20, by means of thumbscrew 144 acting through shaft 143 to nut 142 to grip the clip 141 about the shaft 20.

### DETAILED DESCRIPTION OF THE INVENTION

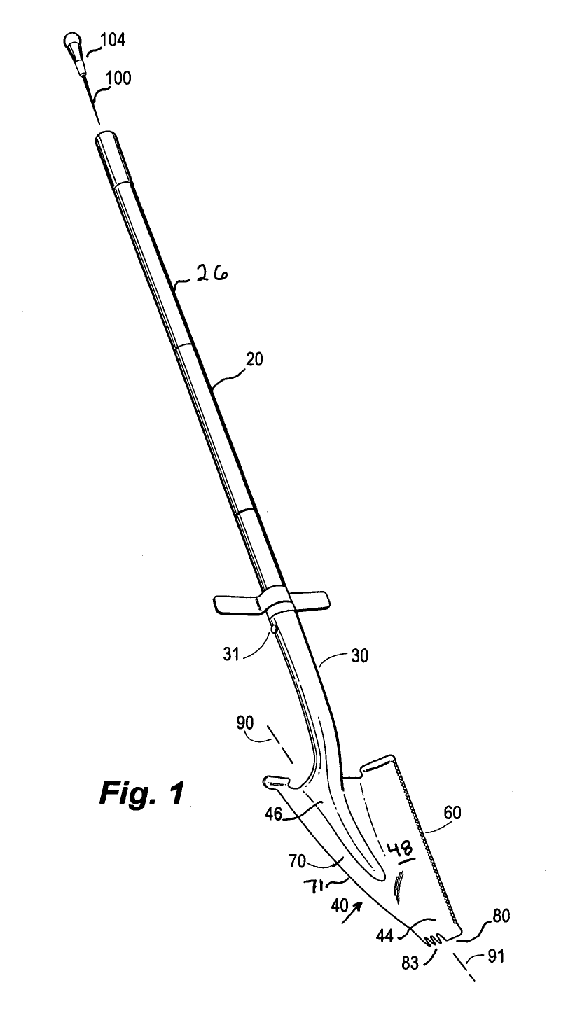

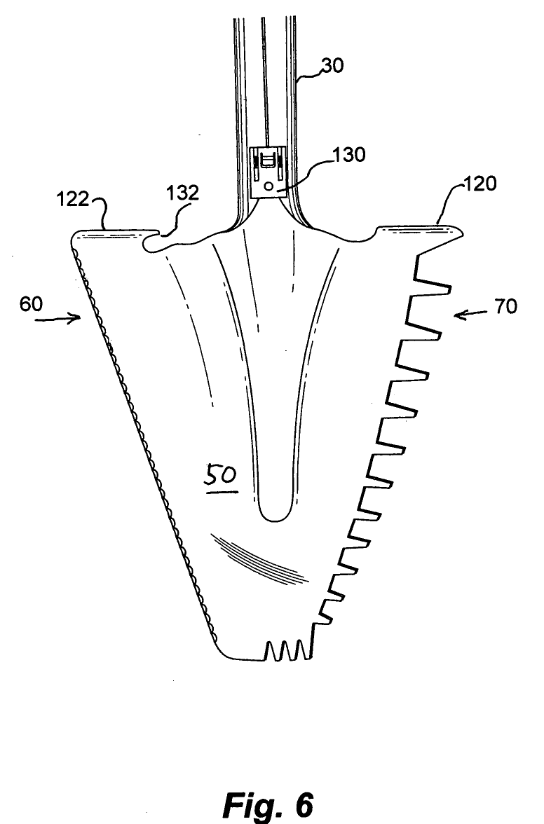

FIG. 1 shows a perspective drawing of one of two equally preferred embodiments of the weeding tool having a shaft 20, a socket 30 into which the shaft 20 fits, connected to the socket 30 by screws 31 and 32 is a tool head 40 having an imaginary major axis 90 shown as a dashed line 90 and 91. The tool head 40 is made as a stamped and trimmed concave or curved metal plate, typically of heat treatable, hardenable steel. The tool head collectively referred to as 40 has a front or nose portion 44 located furthest from the socket 30, a rear portion 46 located adjacent the socket 30, a top surface 48 of the curved plate, a bottom surface 50 (seen in FIG. 6) of the curved plate. There is a left edge 60 between the front 44 and rear 46 portions of the tool head, and a right edge 70 between the front 44 and rear 46 portions of the tool plate.

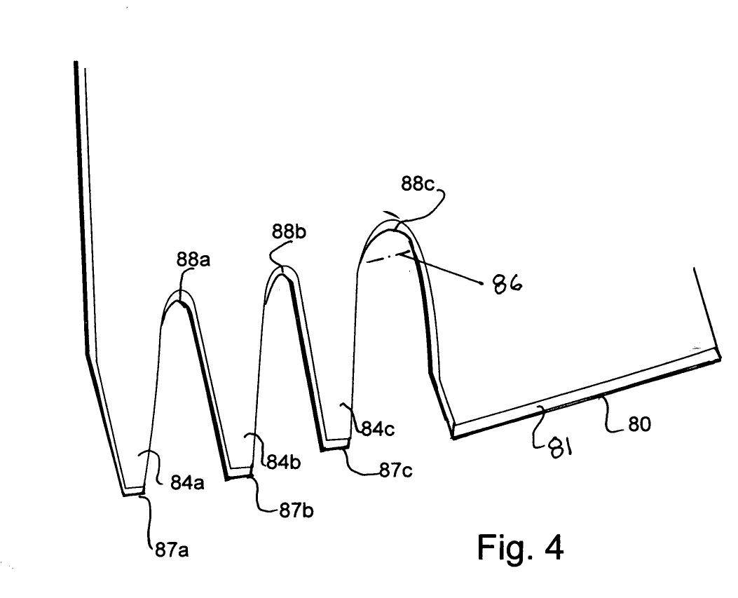

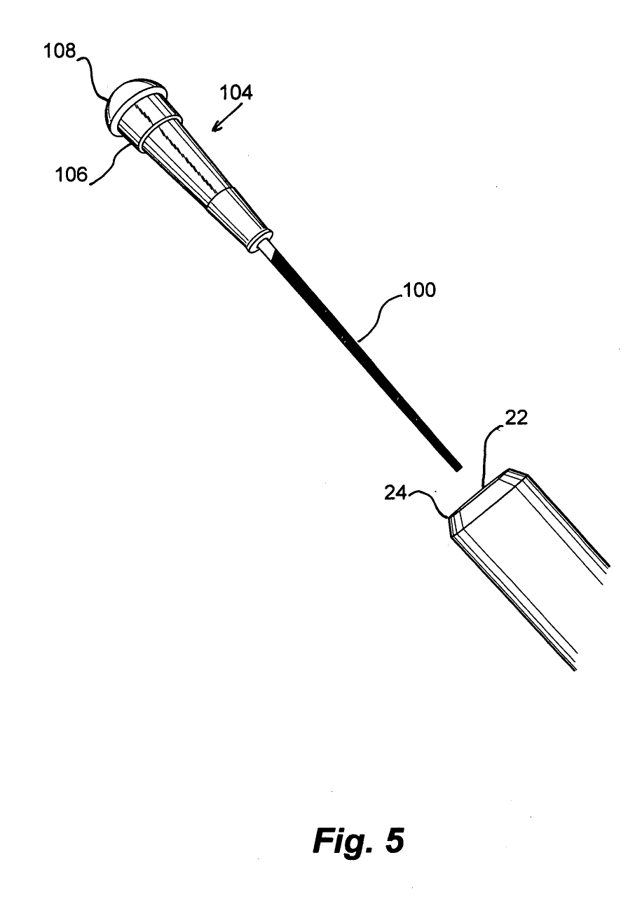

The front portion 44 has cut and formed in it a portion with a sharpenable cutting edge 80 aligned at substantially 30 to 90 degrees from the major axis 90, 91 of the tool head. A beveled edge 81 (seen in FIG. 4) is sharpened to a substantially straight cutting edge. Next to portion 80 is portion 83. Portion 83 has one or more front tines 84a, 84b, 84c, substantially aligned with the major axis 90 of the tool head 40. The front tines such as 84a, 84b, 84c, have one or more sharpenable cutting edges 88a, 88b, 88c, between the front tines whereby a stem or a root of a weed or bush is cut by the cutting edge when the front tines are forced against the stem or root. The sharpenable cutting edges 88a, 88b, 88c between the front tines have substantially elliptical shape when viewed from a plan view of the top surface 48 of the tool head 40. The ellipse results from drilling, milling, or filing the cutting surface at an acute angle by an end mill, drill, or other substantially cylindrical cutting or grinding tool. Because the tool is at an acute angle to the tool head, the result is an elliptical shape. By selecting the minor axis of the ellipse to be slightly larger than a round or half-round fine metal file, the result is that the file will rest in the elliptical shape and will guide even an unskilled person to sharpen most of the edge even though they may hold the file either at too small an acute angle or too large an angle. As a result, even persons who cannot or will not read the instruction manual that accompanies the product will still be able to gain the benefit of a weeding tool that remains sharp despite prolonged use in the field, garden or vineyard.

Using the flat portion of the file, the worker in the field can also sharpen the bevels front of the tines 87a, 87b, 87c, etc.

The importance of sharpness in reducing MSD and other job related risks of prolonged use of manual weeding tools cannot be overstated. A sharp tool can easily cut even substantial roots, with little force, while a dull tool requires an order of magnitude more time and requires several times the force and the shock to the users body to extract the same root, bush, or weed.

Very few persons know the concepts necessary to correctly free hand sharpen a blade. The weeding patent literature is virtually devoid of references to re-sharpening weeding tools. Yet weeding tools which use sharp edges to cut weeds lose their sharpness in hours. Further, rust quickly takes the edge off most sharp cutting edges.

In this invention, the diameter of the file and the diameter 86 of the minor axis of the ellipse are nearly the same so that the round or half-round file which is passed over the edge 88c, for example, will definitely touch some of the cutting edge 88c, even though the file may be held at some angle different from the ideal angle for sharping. Normally, that angle is near 20 degrees. Few people have the knowledge, skill and self-discipline to hold the file at the exact angle. But, this design achieves sharpening, by the user, while in the field by selecting the shape of the cutting edge, for example 88c , to closely interfit and guides the file 100 when that file is passed between the tines at an acute angle to the tool head. Even as an unskilled person tends to rock the file as they pass it over the cutting edge, the result, inevitably, is to remove slight amounts of metal from the cutting edge and thus provide a new and sharp edge.

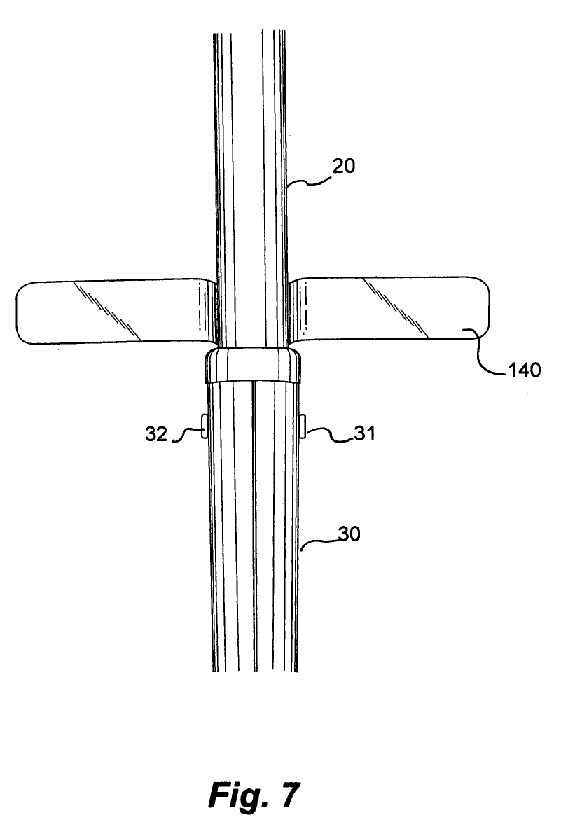

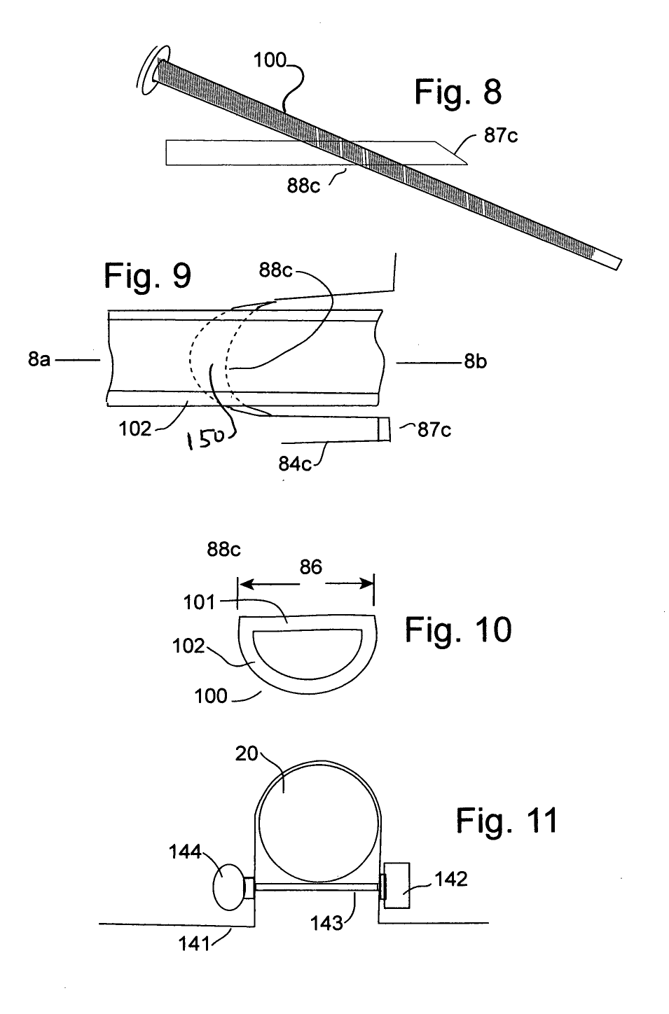

FIG. 8 shows the round or half-round file 100 being applied at nearly the correct angle for sharpening scallop 61a. But, because the diameter of the file is closely matched to the diameter of the scallop 61a, the file is going to sharpen some portion of the elliptical cutting edge.

The front tines 84a, 84b, 84c, etc., have piercing edges 87a, 87b, 87c, formed at the end of the front end of the front tines. These edges enable the tool to break into hard-pan soil, as well as to penetrate into woody trunks of bushes. The sharp edges can be frusto-conical, or conical, or beveled one or more sides, so long as they come to a substantially sharp edge or point.

As explained in the prior art section, one function and advantage of the invention is that a person steps onto the rear portion of the tool head in order to drive the tool into hard ground will find that the tool does not instantly wobble as does a round point shovel. This is due to the equal lengths of the cutting edge 80 and the tips of the front tines 87a, 87b, and 87c. Because the weeder presents a relatively wide “wheel base” as it were, the weeder will not cause the person to tumble to one side or the other. This in turn avoids one of the most frequent injuries to a persons back when they are gardening or weeding.

Along the left edge 60 of the tool head 40 is arrayed cutting means comprising one or more beveled sharpenable cutting edges 61a, 61b, 61c, etc. formed in the left edge 60. The cutting edges are formed in the tool head 40 by either stamped, embossing, heating and embossing, grinding, or mill scallop shaped depressions in the tool head material so as to form thin cutting edges 6la, 61b, 61c, etc. These edges are adapted to permit cutting of weeds, roots, bushes and soil as the tool head is moved relative to said weeds, roots, bushes, and soil. The cutting edges accomplish this by functioning as a serrated knife.

As shown in FIG. 3, the scallop shaped cutting edges can be arrayed along side the tool head 40. FIG. 6 shows that the scallop shapped cutting edges can also be on the rear surface 50 along the edge 60, and indeed, they can overlap with each other and overlap with the scallop shaped cutting edges on the front surface.

As the person using the tool seeks to clear weeds, he or she either swings the tool against the base of the weeds so that the cutting edges 61a, 61b, 61c, etc. contact the weeds and cut them, or, in heavy weeds, the tool can be pushed in a back and forth manner while swing it, to achieve a sawing motion. Then on the opposite swing, the side tines 71a, 71b, 71c engage the weeds and gather them. The end of the return swing to the right is to lift the bundle of weeds like a pitch fork would, and toss the weed bundle, or else deliver the bundle into a container.

Particularly in fighting wild fires, this technique with this tool is many times faster than using a Pulaski. Likewise, road maintenance crews can achieve much faster results by weeding with the invention than by conventional means.

Preferably, one or more folded edges 120 and 122 are formed along the rear 46 portion of the tool head 40 and aligned at between 60 and 90 degrees from the major axis of the tool head, such that a user of the tool can apply force to the tool head by placing his foot on either folded edge 120 or 122, and shoving the tool head 40 into a weed or the earth or both.

The handle for the tool head 40 is preferably a shaft 20 having a hollow portion 22, and within that hollow portion is disposed a file 100 adapted to be used to sharpen one or more of the cutting edges located on the tool head. The file 100 is attached preferably to a handle 104, which embraces the file 100. The handle has a portion whose outer radius 106 corresponds to the inner diameter 24 of the hollow portion 22 of the shaft such that the file and its handle can be held in frictional gripping connection when the file is placed inside the shaft. The file handle 104 has a substantially hemispherical elastomeric portion 108 such that the user of the tool may comfortably apply axial force to the hemispherical portion when gripping and pushing the weeding tool.

Along the shaft 20 may be applied an elastomeric coating 26 on part or all of the exterior of the shaft. This helps the user grip the otherwise slippery plastic shaft. The shaft 20 is preferably PVC pipe because that material is plentiful, cheap, and light in weight.

As a added feature, a can or bottle opener 130 be attached to the tool, preferably at the socket 30 region because of the increased strength inherent in folded metal at that point. An alternate form of bottle and can opener 132 can be formed in the plate of the tool head 40 by piercing, stamping, bending and grinding the footstep 122 on that side to accommodate the cutter/hook portion 133.

Onto the shaft can be placed a clip-on bar 140 which attaches to the shaft 20 either by fastener, not shown, or by gripping the shaft 20 by flat-spring action. The clip 140 aids in moving large bushes and to catch long stem weeds. FIG. 7 shows clip-on bar 140 which grips the shaft 20 and FIG. 9 shows clamp-on bar 141 which grips the shaft by thumbscrew 144 interfitting with nut 142.

In use, the tool is particularly useful for gardening and lawn work, because the sharpened cutting edge 80 may be used effectively to trim growth parallel to sidewalks, and adjacent to sprinkler heads.

The shaft 20 preferably is long enough to allow the person to stand with proper posture while working, but the person could also cut off a portion of the shaft 20 with a hack saw or other implement, and thus shorten the length of the shaft 20 to suit their needs. The overall design allows this “self-adjustment” feature, because the file is adapted to fit any end-portion of the constant inside diameter of the shaft.

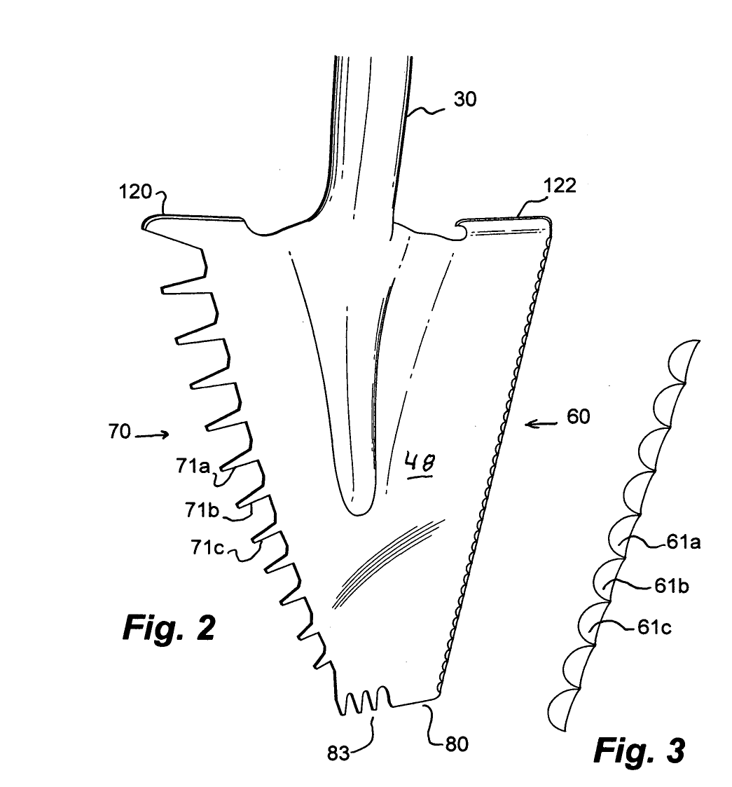

FIGS. 2 and 6 show the second equally preferred embodiment, wherein additional tines are arrayed along one side 70 of the plate 40. FIG. 2 shows the front side of the plate 40, and FIG. 6 shows the rear side of plate 40. In weeding and brush clearance, the additional tines on the side are particularly useful as a rake. While the placement of side tines was described above as being on right edge 70, they could just as well be on edge 60, in which case, the cutting edges 61a, 61b, 61c, etc. would be on the right side. This would adapt the tool to persons whose dominant hand is the left hand.

FIG. 8 is a broken out sectional view along axis 8a-8b as shown in FIG. 9. File 100 is at an acute angle to the tine 87c. Sharpenable edge 88c would ordinarily become dull within hours after being used for weeding. The file, stored in the shaft, is used by the worker to sharpen edge 88c. Because the diameter 86 of the file corresponds closely to the width of the sharpenable edge 88c, and because the file tends to nest against the elliptical edge and elliptical surface 150, the file tends to contact the sharpenable edge 88c at just the right acute angle. Typically this angle is 20 degrees. Although the worker will rarely hold the file at the correct acute angle for efficient accurate sharpening, the file will, nevertheless, sharpen enough of the edge during most of the strokes by which the file is passed over the sharpenable edge 88c. This is important because most persons using the shovel have or, will not, or cannot read the instruction manual explaining how to sharpen a metal edge. The purpose of the invention is to encourage sharpening of the cutting edges every few hours, and this means, the sharpening is to be done in the field.

FIG. 9 is a top view showing in dotted lines the elliptical profile of the typical sharpenable cutting edge 88c. A similar elliptical profile is found in the scallops 61a, 61b, 61c, . . . and is sharpenable in the same manner. FIG. 10 is a cross sectional of the file, showing a half-round cutting ridge 102 and a flat top cutting ridge 101. The flat top 101 of the file is useable for sharpening straight edges such as 87c and a straight edge along 71 along edge 70 as shown in FIG. 1. Returning to FIG. 10, the diameter 86 is matched to the diameter of the sharpenable edges such as shown in FIG. 4, at 88c to reduce rocking of the file as the unskilled or tired worker attempts to sharpen the sharpenable edges of the tool. FIG. 11 shows an alternative means of firmly attaching the clip 141 to the shaft 20, by means of thumbscrew 144 acting through shaft 143 to nut 142 to grip the clip 141 about the shaft 20. The function of the clip as shown in FIG. 11, FIG. 1, and FIG. 7 is to enable an attack, at a distance, on large or stringy brush and weeds, and to pull the weeds and brush out and control it during handling.

It is to be understood that the present invention is not limited to the embodiment described above, but encompasses any and all embodiments within the scope of the following claims:

1. A weeding tool having a shaft,
a socket into which the shaft fits, connected to the socket is a tool head having a major axis and comprising a curved plate having a front portion located furthest from the socket,
a rear portion located adjacent the socket,
a top surface of the curved plate,
a bottom surface of the curved plate,
a left edge between the front and rear portions,
a right edge between the front and rear portions,
said front portion has cut and formed in it a portion with a sharpenable cutting edge aligned at substantially 45 to 90 degrees from the major axis of the tool head,
and another portion of the front portion having one or more front tines aligned with the major axis of the tool head.

2. The weeding tool of claim 1, further comprising one or more sharpenable cutting edges between the front tines whereby a stem or a root of a weed or bush is cut by the cutting edge when the front tines are forced against the stem or root.

3. The weeding tool of claim 2 wherein the sharpenable cutting edges between the front tines have substantially elliptical radii when viewed from a plan view of the top surface of the tool head, and which closely interfits and guides a file when that file is passed between the tines at an acute angle to the tool head whereby the cutting edge is sharpened when the file is pressed against and moved relative to the cutting edge.

4. The weeding tool of claim 1, further comprising front tines having a piercing edge formed at the end of the front end of the front tines.

5. The weeding tool of claim 1 further comprising, one or more side tines formed at selectively spaced intervals along the right edge of the tool head and oriented at an angle between 30 to 90 degrees from the major axis of the tool head.

6. The weeding tool of claim 1 further comprising, cutting means aligned along the left edge of the tool head, said cutting means comprising one or more beveled sharpenable cutting edges formed in the left edge, which cutting edges are adapted to permit cutting of weeds, roots, bushes and soil as the tool head is moved relative to said weeds, roots, bushes, and soil.

7. The weeding tool of claim 1 further comprising, one or more tines located on the left edge of the tool head and aligned at an angle between 30 to 90 degrees from the major axis of the tool head.

8. The weeding tool of claim 1 further comprising, aligned along the right edge of the tool head are one or more hollow ground serrated cutting edges formed in the right edge and adapted to permit cutting as the tool head is moved relative to weeds, roots, bushes, and soil.

9. The weeding tool of claim 1 further comprising one or more folded edges along the rear of the tool head and aligned at between 60 and 90 degrees from the major axis of the tool head, such that a user of the tool can apply force to the tool head by placing a foot on the edge and driving the tool head into a weed or the earth or both.

10. The weeding tool of claim 1 further comprising a shaft having a hollow portion, and within that hollow portion is disposed a file adapted to be used to sharpen one or more of the cutting edges located on the tool head.

11. The weeding tool of claim 10 further comprising a handle attached to the file, said handle having a portion whose outer radius corresponds to the inner diameter of the shaft such that the file and its handle can be held in frictional gripping connection when the file is placed inside the shaft.

12. The weeding tool of claim 11 further comprising a file handle having a substantially hemispherical elastomeric portion such that the user of the tool may comfortably apply axial force to the hemispherical portion when gripping and pushing the weeding tool.

13. The weeding tool of claim 1 further comprising an elastomeric coating on part or all of the exterior of the shaft.

14. The weeding tool of claim 1 further comprising a can opener attached to the tool.

15. The weeding tool of claim 1 further comprising a bottle opener formed in the plate of the tool head.

16. A weeding tool having a shaft,
a socket into which the shaft fits, connected to the socket is a tool head comprising a formed plate having a front portion located furthest from the socket,
a rear portion located adjacent the socket,
a top surface of the formed plate,
a bottom surface of the formed plate,
a left edge between the front and rear portions,
a right edge between the front and rear portions,
said front portion has formed in it a portion with a cutting edge aligned at 70 to 90 degrees from a major axis of the tool head, and another portion having one or more tines aligned with the major axis of the tool head,
between the front tines are located one or more cutting edges such that the stem or root of a weed is trapped and cut by the cutting edge,
said cutting edge having a shape which interfits and guides a file such that when that file is passed at an acute angle to the tool head the cutting edge is sharpened as the file is pressed against and moved relative to the cutting edge, and
alongside one side of the tool head is aligned tines oriented at an angle between 30 to 90 degrees from the major axis of the tool head, and on the opposite edge of the tool head are one or more hollow ground serrated cutting edges formed in the left edge and adapted to permit cutting as the tool head is moved relative to flora and earth.

17. The weeding tool of claim 16 further comprising one or more folded edges along the rear of the tool head and aligned at between 60 and 90 degrees from the major axis of the tool head, such that a user of the tool can apply force to the tool head by placing a foot on the edge and driving the tool head into a weed or the earth or both.

18. The weeding tool of claim 16 further comprising a shaft having a hollow portion, and within that hollow portion is disposed a file adapted to be used to sharpen one or more of the cutting edges located on the tool head.

19. The weeding tool of claim 1 further comprising a clip on bar which attaches to the shaft and which aids in moving large bushes and weeds.
